(19) United States
(12) Patent Application Publication
(10) Pub. No.: US 2013/0070163 A1
(43) Pub. Date: Mar. 21, 2013

(54) REMOTE CONTROL WITH WEB KEY TO INITIATE AUTOMATIC INTERNET SEARCH BASED ON CONTENT CURRENTLY DISPLAYED ON TV

(71) Applicant: KIRSTIN CONNORS, San Diego, CA (US)

(72) Inventor: KIRSTIN CONNORS, San Diego, CA (US)

(73) Assignee: SONY CORPORATION

(21) Appl. No.: 13/236,045

(22) Filed: Sep. 19, 2011

(51) Int. Cl. H04N 5/44

(52) U.S. Cl. 348/734; 348/E05.097

(57) ABSTRACT

A remote control (RC) for an audio video display device (AVDD) such as a TV has a special “web” key which, when pressed, causes the RC to command the TV to upload, the currently presented screen shot (or current audio, or current key words in closed captioning (CC)) to a searching device such as an Internet server, the RC processor, or the TV processor. The searching device executes a search based on images recognized in the screen shot Or audio or key words from the CC. If multiple objects are detected a list of the objects may be presented on the TV display or RC display for selection of one by the viewer. The selected object or sole recognized object is then searched using an Internet search engine and the results returned for display.

### I. FIELD OF THE INVENTION

The present application relates generally to remote controls (RC) for TVs that include special keys to initiate automatic Internet searches for objects in content currently presented on a TV display with which the RC communicates.

### II. BACKGROUND OF THE INVENTION

As understood herein, many televisions (TVs) and other audio Video; display devices (AVDDs) have Internet capability. As also understood herein, however, the provision of Internet capability into a TV does not provide for near-seamless integration of Internet searches with content presentation on the TV in that a viewer observing or hearing something of interest and desiring to search the Internet for further information on that item of interest typically must execute a conventional keyboard-centric search, detracting from the viewing experience.

### SUMMARY OF THE INVENTION

According to principles set forth below, a system includes an audio video display device (AVDD) including a video display and a remote control (RC) wirelessly communicating user-input commands to the AVDD to control the AVDD. The RC includes a Web key. A server communicates with the RC. Responsive to actuation of the Web key, the RC sends a command to the AVDD to upload an image substantially currently presented on the video display for provision of the image to the server. In turn, the server, responsive to receiving the image, automatically executes image recognition of objects in the image and correlaes recognized objects to at least one search term that is searchable by an Internet search engine to return results conforming to the search term.

In some implementations, responsive to deriving one and only one search term from the image, the server automatically executes an Internet search on the search term and automatically sends results of the Internet search back to the RC and/or AVDD, On the other hand, responsive to deriving plural search terms from the image, the server may automatically send a list of at least some of the search terms to the RC and/or AVDD for selection of a desired search term by a user. In this case, the server, responsive to receiving the desired search term, automatically executes an Internet search on the desired search term and automatically sends results of the Internet search back to the RC and/or AVDD.

In some example embodiments, responsive to actuation of the Web key the RC sends a command to the AVDD to upload an image substantially currently presented on the video display to the RC for provision by the RC of the image to the server. In other implementations, responsive to actuation of the Web key the RC sends a command to the AVDD to upload an image substantially currently presented on the video display directly to the server, bypassing the RC.

In addition to searching based on video, if desired, responsive to actuation of the Web key the RC can send a command to the AVDD to upload a clip of audio being currently presented on. the AVDD for provision of the clip to the server. The server responsive to receiving the clip automatically executes voice recognition of words in the clip and correlates the words to at least one search term searchable by an Internet search engine to return results conforming to the search term. Moreover, responsive to actuation of the Web key the RC may further send a command to the AVDD to upload key words in closed captioning (CC) associated with programming being currently presented on the AVDD for provision of the key words to the server. The server responsive to receiving the key words correlates the key words to at least one search term searchable by an Internet search engine to return results conforming to the search term.

In another aspect, a remote control (RC) for an audio video display device (AVDD) includes a housing and a “web” key on the housing which, when pressed, causes the RC to command the AVDD to upload a portion of a program being currently presented on the AVDD to a searching device for executing an Internet search based on the portion of the program.

In another aspect, a method includes receiving a selection signal from a Web key on a remote control (RC) and responsive to the selection signal, causing an audio video display device (AVDD) to capture a portion of content being substantially currently presented on the AVDD. The portion of content is correlated to an Internet search term and results of a search on the Internet search term are presented on the RC or AVDD.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting example system in accordance with present principles;

FIG. 2 is a flow chart of example general logic in accordance with present principles;

FIG. 3 is a flow chart of detailed logic in accordance with a first embodiment;

FIG. 4 is a flow chart of detailed logic in accordance with a second embodiment;

FIG. 5 is a flow chart of detailed logic in accordance with a third embodiment;

FIG. 6 is a screen shot of a list of recognized objects, prompting a viewer to select an item from the list for search;

FIG. 7 is a screen shot of an example non-limiting search results Web page; and

FIG. 8 is a screen shot of a user interface allowing a person to select one or more of the search paradigms to execute from FIGS. 3-5 when the Web key is actuated.

### DETAILED DESCRIPTION OF THE PREFERRED EMBODIMENT

Referring initially to the non-limiting example embodiment shown in FIG. 1, a system 10 includes an audio video display device (AVDD) 12 such as a TV including a TV tuner 16. communicating with a TV processor 18 accessing a tangible computer readable storage medium 20 such as disk-based or solid state storage. The AVDD 12 can output audio on one or more speakers 22. In example embodiments the AVDD 12 can receive streaming video from the Internet using a built-in or external wired or wireless network interface 24 (such as a modem or router) communicating with the processor 12 which may execute a software-implemented browser. Video is presented under control of the TV processor 18 on a TV display 28 such as but not limited to a high definition TV (HDTV) flat panel display, and may be a screen display. User commands to the processor 18 may be wirelessly received from a typically portable, hand-held remote control (RC) 30 at an infrared (IR) received 32 communicating with the processor 18. If desired, a short range wireless transceiver 34 such as a Bluetooth radio frequency (RF) transceiver may communicate with the RC 30 and TV processor 18.

Accordingly and turning now to the RC 30, an RC processor 36 in the RC 30 may receive user input signals from a keypad 38 and transmit corresponding commands responsive to the signals from the keypad 38 through an IR transmitter 40 to the IR receiver 32 of the AVDD 12, for execution thereof by the TV processor 18. Also, the RC processor 36 may communicate with a short range wireless transceiver 42 that is complementary to the short range wireless transceiver 34 of the AVDD 12 to establish communication of information between the RC 30 and AVDD 12 in accordance with certain embodiments below. The RC processor 36 may access a computer readable storage medium 44 on which may be stored a software-implemented Web browser 46 to access, through a wired or wireless network interface 48, the Internet, in some cases through an access point (AP) 50 such as a wireless router. Logic in accordance with present principles may be stored in the form of computer instructions on one or more of the computer readable storage media described herein.

As also shown in FIG. 1, the RC 30 also includes a special “Web” key 52 for purposes to be shortly disclosed. In some implementations the “Web key” 52 is a standalone hardware key with the single purposes of initiating automatic searches according to disclosure below. In other embodiments the Web key 52 may be established by an otherwise multi-purpose key or combination of keys on the keypad 38, which may be a conventional RC keypad. In this latter case the RC processor 36 is programmed with software to define which key or key combination on the keypad 38, when actuated by a person, is to initiate the logic described herein. The RC 30 furthermore, may include a typically small video display 54. The RC 30 (and/or TV if desired) may include, a microphone 53 and speakers 55.

Completing the description of FIG. 1, the RC 30 and/or AVDD 12, through their respective network interfaces 48, 24 (and if needed the AP 50), can communicate with one or more Internet search servers 56 having one or more server processors 58 accessing one or more computer readable storage media 60 according to logic described below.

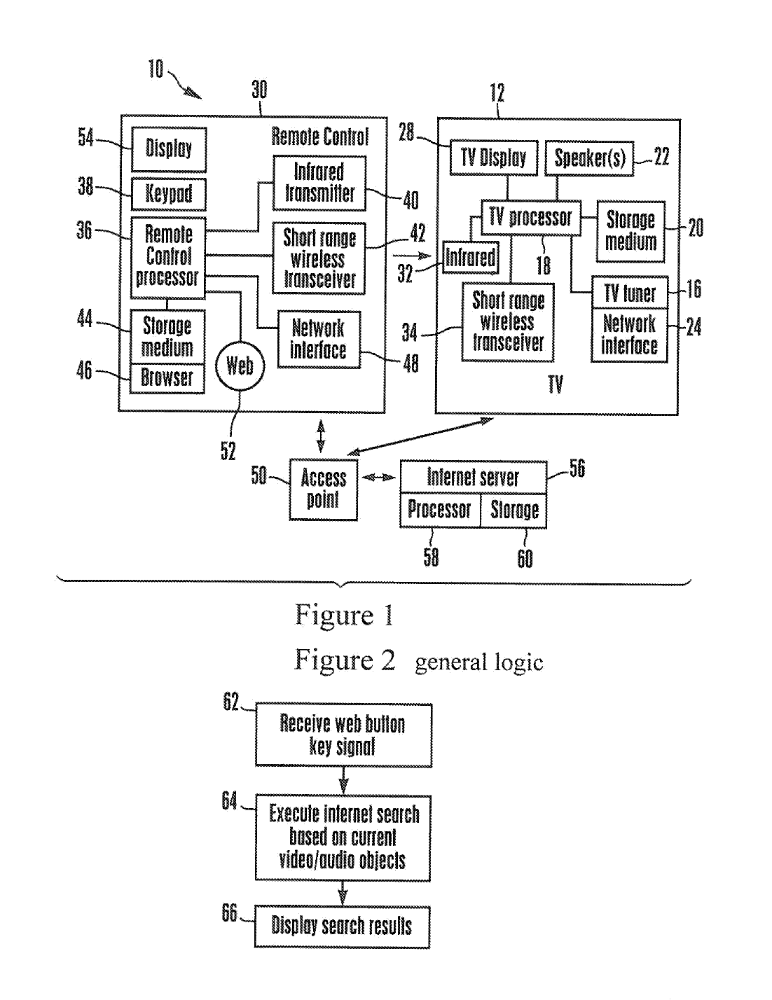

Turning now to FIG. 2, general logic according to present principles may be seen. Commencing at block 62, a signal is received from the Web key 52 by the RC processor 36 when a person actuates the Web key 52. In response to receiving the RC key signal, the logic moves to block 64 to execute an Internet search based on objects being currently presented on the TV display 28 or represented by audio played on the speakers 22 or represented by key words in closed captioning (CC) text accompanying the audio and video on the AVDD 12. Note that these three modes of object-based search, described further below, are not necessarily mutually exclusive. Multiple objects from the video, audio, and CC may be recognized and the below-described selection list shown in FIG. 6 presented listing the objects for selection of one or more for search. In any case, as divulged further below the search at block 64 typically is conducted by the server 56 but may alternatively be conducted by the AVDD 12 or RC 30. The logic ends at block 66 by presenting the results of the Internet search on the RC display 54 and/or on the TV display 28.

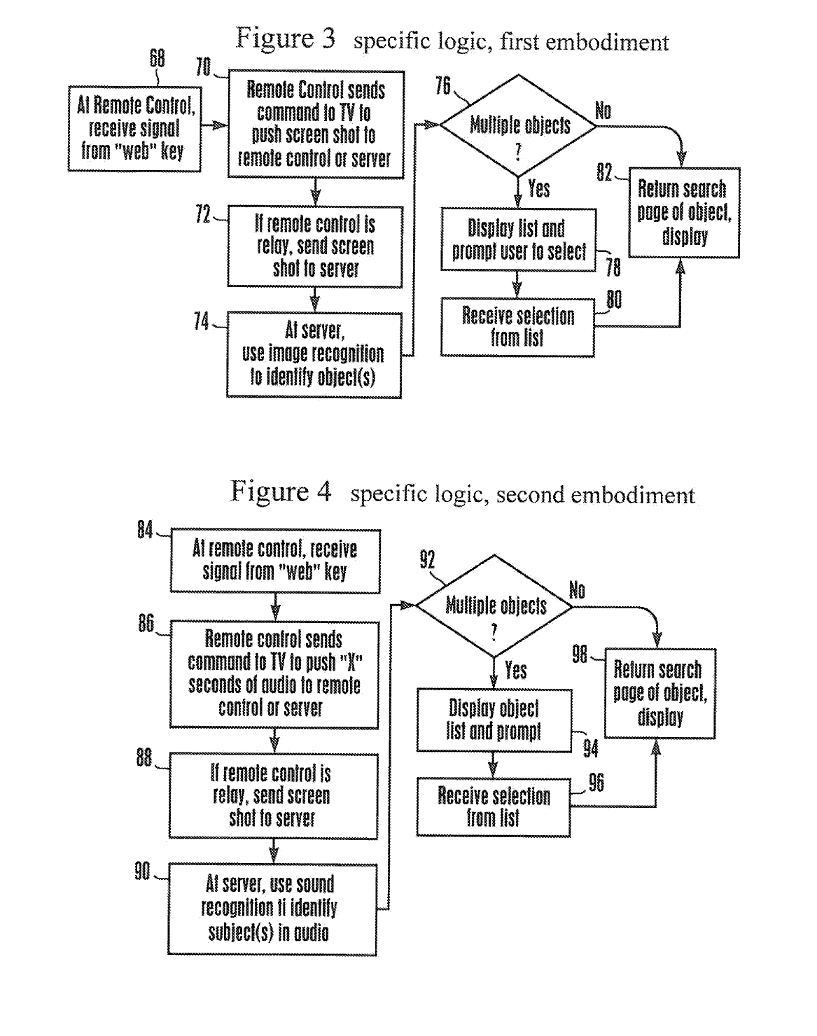

FIG. 3 illustrates more detailed logic according to a first embodiment. Commencing, at block 68, the RC processor 36 receives a signal from the Web key 52 when a person actuates the Web key 52. In response to receiving the RC key signal, the logic moves to block 70, wherein the RC/processor 36 sends, via the IR transmitter 40 or short range wireless transceiver 42, a command to the AVDD 12 to capture a screen shot of the video being substantially currently presented on the TV display 28. Recognizing small temporal delays between pressing the Web key and capturing an image of video which changes typically at a 32 frame per second refresh rate, by “substantially currently” presented is meant the image that is being presented at the time the AVDD can receive and process the command and grab the screen shot, which to the viewer is expected to be an imperceptibly short time after pressing the Web key. In one implementation, the command is for the AVDD 12 to send, typically via the short range wireless transceivers 34, 42, information representing the screen shot to the RC 30, although in other embodiments the command may be for the AVDD 12 to send the screen shot directly to the server 56 or even to send it to the TV processor 18 for execution of ensuing logic. Note that embodiments requiring the AVDD to simply return the screen shot to the RC require minimal software upgrade to the AVDD, with the logic and server address being contained in the RC. When the AVDD is commanded to send the screen shot directly to the server, the server address may be preprogrammed into the AVDD or may be sent to the AVDD by the RC as part of the Web key command.

In the preferred yet example embodiment shown, assuming the server 56 is to undertake the recognition processing, at block 72 if the command at block 70 was to upload the screen shot to the RC, the RC 30 in turn sends the screen shot to the server 56. Of course, the step at block 72 is not necessary when the AVDD 12 is commanded at block 70 to upload the screen shot direct to the server, or in embodiments in which the TV processor 18 executes the recognition and search logic below.

Proceeding to block 74, at the server 56 (or in embodiments in which the TV processor 18 is assigned this task, at the AVDD 12) image recognition is executed on the screen shot. Appropriate image recognition software may be used for this purpose. Multiple objects may be recognized in the screen shot, e.g., a screen shot of the character “Spiderman” wearing a sweater may result in the recognition of both. Spiderman and a sweater garment.

Moving to decision diamond 76, it is determined by the processor executing the image recognition (typically, the server processor 58) whether in fact multiple objects have been recognized in the screen shot image. If so, the logic proceeds to block 78 to present, on the RC display 54 and/or TV display 28, a list of the recognized objects and a prompt for a viewer to select which object on the list is to be searched. An example recognized object list is presented in FIG. 6, discussed further below. The viewer selection from the list is received at block 80 (when the server 56 executes the logic, from the RC 30 or AVDD 12 through their respective network interfaces) and at block 82 an Internet search is executed on the name of the object. The search results are returned for presentation on the RC display 54 and/or TV display 28 at block 82. Note that when only a single object is recognized at decision diamond 76, the logic flows directly to block 82 as shown.

FIG. 4 illustrates more detailed logic according to a first embodiment. Commencing at block 84, the RC. processor 36 receives a signal from the Web key 52 when a person actuates the Web key 52. In response to receiving the RC key signal, the logic moves to block 86, wherein the RC processor 36 sends, via the IR transmitter 40 or short-range wireless transceiver 42, a command to the AVDD 12 to capture a small clip of audio (e.g., audio of a few seconds of length) being currently presented on the TV speaker 22. In one implementation, the command is for the AVDD 12 to send, typically via the short range wireless transceivers 34, 42, information representing the audio to the RC 30, although in other embodiments the command may be for the AVDD 12 to send the audio directly to the server 56 or even to send it to the TV processor 18 for execution of ensuing logic.

In the preferred yet example embodiment shown, assuming the server 56 is to undertake the recognition processing, at block 88 if the command at block 82 was to upload the audio to the RC, the RC 30 in turn sends the audio to the server 56. Of course, the step at block 88 is not necessary when the AVDD 12 is commanded at block 86 to upload the audio direct to the server, or in embodiments in which the TV processor 18 executes the recognition and search logic below.

Proceeding to block 90, at the server 56 (or in embodiments in which the TV processor 18 is assigned this task, at the AVDD 12) sound recognition is executed on the audio. Appropriate voice recognition software may be used for this purpose. Multiple objects may be recognized in the audio, e.g., audio of the character. “Spiderman” wearing a sweater may result in spoken words in the audio of both “Spiderman” and “sweater” and the resulting recognition of both Spiderman and a sweater garment.

Moving to decision diamond 92, it is determined by the processor executing the image recognition (typically, the server processor 58) whether in fact multiple objects have been recognized in the audio. If so, the logic proceeds to block 94 to present, on the RC display 54 and/or TV display 28, a list of the recognized objects and a prompt for a viewer to select which object on the list is to be searched. An example recognized object list is presented in FIG. 6, discussed further below. The viewer selection from the list is received at block 96 (when the server 56 executes the logic, from the RC 30 or AVDD 12 through their respective network interfaces) and at block 94 an Internet search is executed on the name of the object. The search results are returned for presentation on the RC display 54 arid/or TV display 28 at block 94. Note, that when only a single object is recognized at decision diamond 92, the logic flows directly to block 98 as shown.

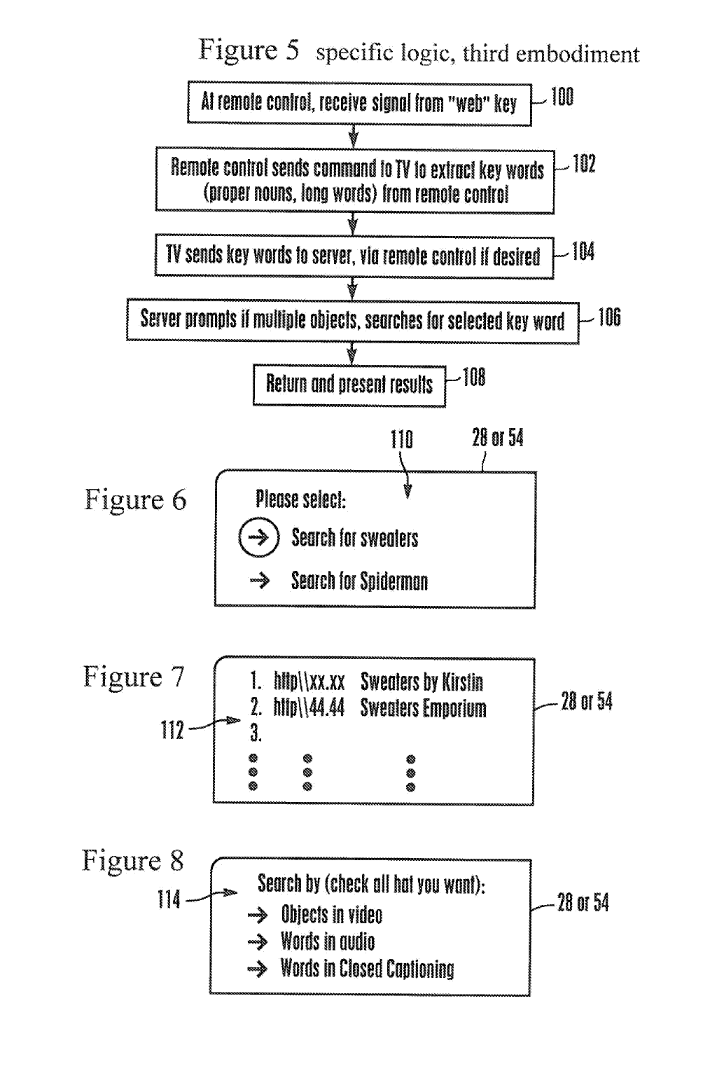

FIG. 5 shows yet a third embodiment commencing at block 100 with the reception of a Web key 52 actuation signal. Moving to block 102, the RC commands the AVDD 12 to extract key words such as proper nouns and long words from the closed captioning (CC) accompanying the program being presented on the AVDD 12. To this end, the TV processor 18 can execute a limited grammar voice recognition engine. Moving to block 104 and again assuming that the search will be conducted by the server 56, the AVDD 12 sends the extracted key words to the server 56, via the RC 30 if desired. When multiple key words are recognized, at block 106 the object list of FIG. 6 is presented, on the RC 30 or AVDD 12. Note that the logic at block 106 may be executed by the server 56 sending the list to the AVDD 12 or by the AVDD 12 prior to executing the logic of block 104, to save a transmission step.

In any case, once a key word for search has been identified, either by the user selecting a word from the list of FIG. 6 or by only a single key word being captured from the CC, at block 106 ah Internet search is conducted using the key word as entering argument and the results returned for display at block 108 from the server to the RC 30 and/or AVDD 12.

FIG. illustrates the above-discussed object list 110. A list of recognized objects from the current (relative to the Web!key being actuated) screen shot and/or audio and/or CC text is presented on the RC display 54. In some embodiments the list 110 may be presented on the TV display 28. The list is accompanied by the illustrated example prompt to select an item from the list. In the example shown, the circle around the arrow for “search for sweaters” indicates that the user has elected to search for sweaters.

FIG. 7 simple illustrates an. example Web search results page 112 that may be presented at any of blocks 82, 98, and 108 discussed above. As shown, the results page 112 can list multiple web sites by Internet address and title for selection of a site by the viewer in accordance with principles known in the art. The selected page can then be presented on the RC display 54 and/or TV display 28.

It may now be appreciated that simply by pressing the Web key 52 when the viewer observes or hears something of interest on the AVDD 12, an Internet search is automatically conducted on the item of interest without requiring the viewer to input any search terms or web addresses beyond a potential choice of recognized objects from FIG. 6, which can be undertaken by simple RC cursor control and selection, requiring no cumbersome text input on the part of the viewer.

FIG. 8 shows that if desired, a user interface 114 may be presented on the RC display or TV display to enable a person to select one or more of the above-described search modes, i.e., whether, upon actuation of the RC key 52, to search by recognized objects in the current screen shot on the AVDD 12, by recognized key words in audio, and by recognized key words in CC. Thus, in some implementations the user is given the option to select one or more of the above search logic paradigms from FIGS. 3-5.

Recognizing that TV images sometimes include phone numbers displayed on advertisements, the logic herein, upon detecting, by, e.g., image recognition of numerals arranged as a ten digit telephone number, can present a prompt on the TV or RC display asking the viewer “do you want to call?” if so, the viewer, using the RC 30, can select “yes” if desired and the TV or RC can initiate a telephone call, with, the microphone 53 and speakers 55 being used to speak into and listen to the called party.

While the particular REMOTE CONTROL WITH WEB KEY TO INITIATE AUTOMATIC INTERNET SEARCH BASED ON CONTENT CURRENTLY DISPLAYED ON TV is herein shown and described in detail, it is to be understood that, the subject matter which is encompassed by the present invention is limited only by the claims.

What is claimed is:

1. System, comprising:
an audio video display device (AVDD) including a video display;
a remote control (RC) wirelessly communicating user-input commands to the AVDD to control the AVDD, the RC including a Web key; and
a server communicating with the RC, wherein responsive to actuation of the Web key the RC sends a command to the AVDD to upload an image substantially currently presented on the video display for provision of the image to die server, the server responsive to receiving the image automatically executing image recognition Of objects in the image and correlating recognized objects to at least one search term searchable by an Internet search engine to return results conforming to the search term.

2. The system of claim 1, wherein responsive to deriving one and only one search term from the image, the server automatically executes an Internet search on the search term and automatically sends results of the Internet search back to the RC or AVDD or RC and AVDD.

3. The system of claim 1, wherein responsive to deriving plural search terms from the image, the server automatically sends a list of at least some of the search terms to the RC or AVDD or RC and AVDD for selection of a desired search term by a user, the server responsive to receiving the desired search term automatically executes an Internet search on the desired search term and automatically sends results of the Internet search back to the RC or AVDD or RC and AVDD.

4. The system of claim 1, wherein responsive to actuation of the Web key the RC sends a command to the AVDD to upload an image substantially currently presented on the video display to the RC for provision by the RC of the image to the server.

5. The system of claim 1, wherein responsive to actuation of the Web key the RC sends a command to the AVDD to upload an image substantially currently presented on the video display directly to the server, bypassing the RC.

6. The system of claim 1, wherein responsive to. actuation of the Web key the RC sends a command to the AVDD to upload a clip of audio being currently presented on the AVDD for provision of the clip to the server, the server responsive to receiving the clip automatically executing voice recognition of words in the clip and correlating the words to at least one search term searchable by an Internet search engine to return results conforming to the search term.

7. The system of claim 1, wherein responsive to actuation of the Web key the RC sends a command to the AVDD to upload key words in closed captioning (CC) associated with programming being currently presented on the AVDD for provision of the key words to the server, the server responsive to receiving the key words correlating the key words to at least one search term searchable by an Internet search engine to return results conforming to the search term.

8. A remote control (RC) for an audio video display device (AVDD), comprising:
housing;
“web” key on the housing which, when pressed, causes the RC to command the AVDD to upload at least one portion of a program being currently presented on the AVDD to a searching device for executing an internet search based on the portion of the program.

9. The RC of claim 8, wherein the portion is a screen shot of video.

10. The RC of claim 8, wherein the portion is audio.

11. The RC of claim 8, wherein the portion is at least one key word in closed captioning (CG).

12. The RC of claim 8, wherein the RC causes the RC or AVDD to present a user interface allowing a person to select among the portion being video, the portion being audio, the portion being closed captioning.

13. The RC of claim 8, wherein responsive to deriving one and only one search term from the portion an Internet search on the search term is automatically executed and results thereof presented on the RC or AVDD or on the RC and AVDD.

14. The RC of claim 81, wherein responsive to deriving plural search terms from the portion a list of at least some of the search terms is presented on the RC or AVDD or on the RC and AVDD for selection of a desired search term by a user.

15. The RC of claim 8, wherein responsive to actuation of the Web key the RC sends a command to the AVDD to upload an image substantially currently presented on the video display to the RC for provision by the RC of the image to a server.

16. The RC of claim 8, wherein responsive to actuation of the Web key the RC sends a command to the AVDD to upload an image substantially currently presented on the video display directly to the server, bypassing the RC.

17. Method, comprising:
receiving a selection signal from a Web key on a remote control (RC);
responsive to the selection signal, causing an audio video display device (AVDD) to capture a portion of content being substantially currently presented on the AVDD, the portion of content being correlated to an Internet search term and results of a search on the Internet search term being presented on the RC or AVDD.

18. The method of claim 17, wherein the portion is a screen shot of video.

19. The method of claim 17, wherein the portion is an audio clip.

20. The method of claim 17, wherein the portion is closed captioning (CC).
